(19) United States
(12) Patent Application Publication
(10) Pub. No.: US 2025/0302022 A1
(43) Pub. Date: Oct. 2, 2025

(54) FISHING REEL INCLUDING MAGNETS DISPLACEABLE PERPENDICULARLY TO AXIAL DIRECTION OF SPOOL

(71) Applicant: DOYO ENGINEERING CO., LTD., Bucheon-city (KR)

(72) Inventor: Kang Ho HYUN, Bucheon-si (KR)

(21) Appl. No.: 18/621,231

(22) Filed: Mar. 29, 2024

(51) Int. Cl. A01K 89/0155

(52) U.S. Cl. CPC A01K 89/01555

(57) ABSTRACT

Provided is a fishing reel including a variable brake, the position of which changes in the axial direction of a spool, and magnets displaceable perpendicularly to the axial direction of the spool. The distance between the variable brake and the magnet is automatically adjusted, and the positions of magnet holders may be adjusted using a dial. The spool includes a drum on which a fishing line is wound and a shaft provided at the center. A facing member is provided on one side of the drum, and includes a facing portion. A magnetic brake includes holders provided in a circumferential direction of the facing portion to move forwards and backwards in a direction perpendicular to an axial direction of the shaft and magnets mounted on the holders to respectively have a facing surface facing the facing portion. A braking force control means moves the holders forwards and backwards.

### BACKGROUND

### Technical Field

The present disclosure relates to a fishing reel having magnets displaceable in a direction perpendicular to the axial direction of a spool, wherein the magnets generating a braking force on the spool are mounted on a holder movable forwards and backwards in a direction perpendicular to the axial direction of the spool, so that the braking force may be controlled by adjusting the distance of the magnet from a face by which the spool is caused to be braked.

### Description of the Related Art

When a fishing reel is cast, the speed at which the spool rotates to unwind the line is generally faster than the speed at which the lure flies, thereby reducing the flying distance of the lure or tangling the line. This phenomenon is known as backlash.

To prevent such backlash, fishing reels generally use a friction brake using physical friction and a magnetic brake using the attraction of magnets.

In these brakes, the magnetic brake is a non-contact brake different from the friction brake. The magnetic brake uses the attraction of a plurality of magnets provided on a reel body to apply the magnetic attraction to a rotating spool, thereby slowing down the rotation of the spool.

In a magnetic brake of the related art, a ring-type plate is mounted on one side surface of a spool, and a plurality of magnets are arranged in a circle on one side spaced from the plate to face the plate. During high-speed rotation of the spool, the magnetic force of the magnets acts on the plate to generate a braking force, thereby preventing backlash.

The magnetic brake of the related art described above is configured to adjust the distance between the plate and the magnets by moving a holder holding the magnets in the axial direction of the spool, thereby controlling the braking force.

However, since the magnetic brake of the related art adjusts the fine distance between the plate and the magnets facing the plate, the range in which the braking force is controlled may necessarily be narrow. When the holder is moved farther to increase the range in which the braking force is controlled, the size of the body of the fishing reel may increase accordingly, which is problematic.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to provide a fishing reel including magnets displaceable perpendicularly to the axial direction of the spool, the fishing reel enabling a user to use the fishing reel by adjusting braking force according to his/her own fishing style by combining the advantages of the centrifugal brake, the magnetic brake, and the inertia brake of the related art, such as ability to prevent pad wears, ability to prevent casting distance reduction and backlash in low speed rotation of the spool, and compatibility with either a left or right handed handle, and the like.

In order to achieve at least one of the above objectives, according to one aspect of the present disclosure, there is provided a fishing reel including: a spool including a drum on which a fishing line is wound and a shaft provided on a central portion; a facing member provided on one side of the drum of the spool and including a facing portion; a magnetic brake including holders provided in a circumferential direction of the facing portion of the facing member to be movable forwards and backwards in a direction perpendicular to an axial direction of the shaft and magnets mounted on the holders to respectively have a facing surface facing the facing portion; and a braking force control means for moving the holders forwards and backwards.

According to the present disclosure, the fishing reel may include the magnets displaceable perpendicularly to the axial direction of the spool, and may enable a user to use the fishing reel by adjusting braking force according to his/her own fishing style by combining the advantages of the centrifugal brake, the magnetic brake, and the inertia brake of the related art.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is an assembled perspective view illustrating a first embodiment of the present disclosure;

FIGS. 2A and 2B are cross-sectional views illustrating the first embodiment of the present disclosure;

FIGS. 3A and 3B are exploded perspective views illustrating the first embodiment of the present disclosure;

FIGS. 4A and 4B are cross-sectional views illustrating a second embodiment of the present disclosure;

FIGS. 5A and 5B are exploded perspective views illustrating the second embodiment of the present disclosure;

FIGS. 6A and 6B are cross-sectional views illustrating a third embodiment of the present disclosure;

FIG. 7A is a cross-sectional view illustrating a modified embodiment of FIG. 2A;

FIGS. 7B and 7C are side views illustrating the operating states of FIG. 7A, respectively.

FIGS. 8 and 9 are cross-sectional views illustrating a fourth embodiment of the present disclosure; and

FIGS. 10 and 11 are exploded perspective views illustrating the fourth embodiment of the present disclosure.

### DETAILED DESCRIPTION

The present disclosure may be modified in various forms, and aspects (or embodiments) will be described in detail below. However, the present disclosure is not limited to the specific embodiments disclosed and should be understood to include all modifications, equivalents, and substitutions falling within the spirit and technical scope of the present disclosure.

In the drawings, like reference numerals, particularly, reference numerals having the same last two digits or the same last one digit and letter refer to like elements having like functions throughout. Unless the context clearly indicates otherwise, elements referred to by reference numerals of the drawings should be understood according to this standard.

With respect to the components in the drawings, although the components are illustrated in an exaggerated, enlarged (thicker) or miniaturized (thinner) size or thickness or illustrated in a simplified manner for better understanding of the components, the scope protected by the present disclosure should not be construed as being limited by the manner illustrated.

Terms used herein are used to describe a specific embodiment (or aspect) and are not intended to limit the present disclosure, and singular forms are intended to include plural forms unless the context clearly indicates otherwise.

Further, herein, it should be understood that the terms “include” or “include” indicate that a feature, a number, a step, an operation, a component, a part or the combination thereof described in the specification is present, but does not exclude a possibility of presence or addition of one or more other features, numbers, steps, operations, components, parts or combinations thereof in advance.

Unless otherwise defined, all terms including technical and scientific terms used herein have the same meaning as commonly understood by those skilled in the art to which this present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The terms “first”, “second”, and the like are used herein only for the purpose of differentiating between components, and are not used to indicate the order of preparation steps. There may be inconsistencies in naming the terms between the detailed description and the claims.

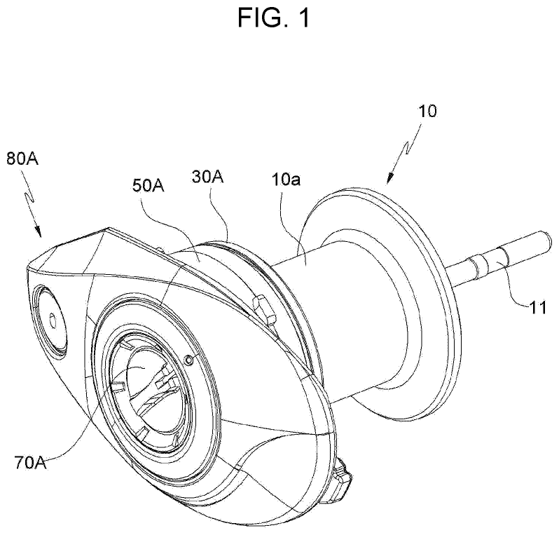

In describing the fishing reel according to the present disclosure, a non-strict orientation standard will be approximated for convenience with reference to FIG. 1 such that up, down, left, and right are determined according to the direction of view, with the direction in which gravity acts being the downward direction.

Hereinafter, a fishing reel according to the present disclosure will be described with reference to the accompanying drawings.

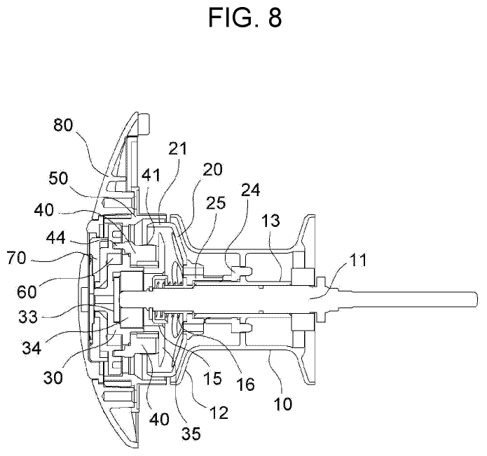

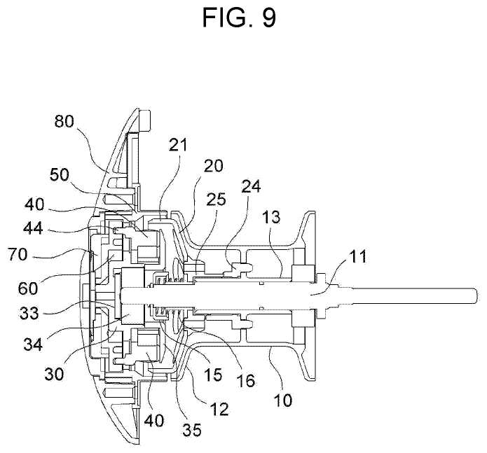

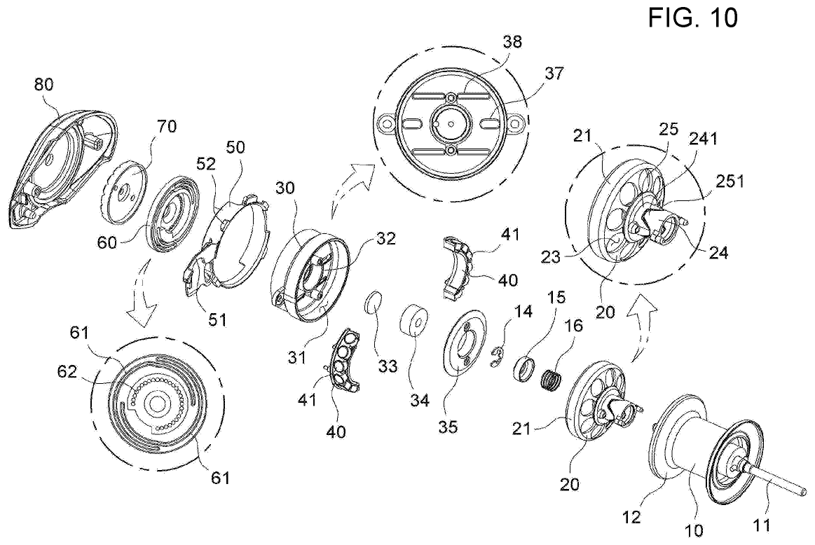

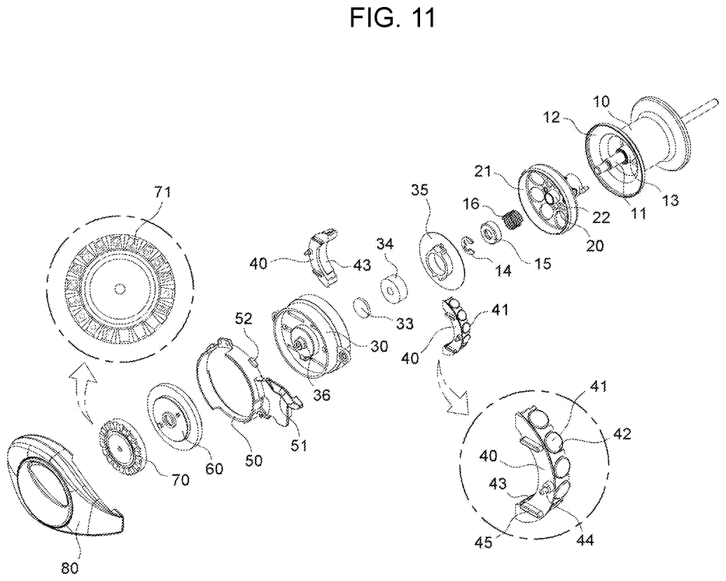

As illustrated in FIGS. 1 to 11, the fishing reel according to the present disclosure includes a spool 10, a variable brake 20, a spool cover 30A, 30B, 30C, or 30, magnet holders 40A, 40B, 40C, or 40, a rocking lever 50, a dial cam 60A, 60B, 60C, 60D, or 60, a control dial 70 or 70A, and a side cover 80 or 80A. The dial cam 60A, 60B, 60C, 60D, or 60 and the control dial 70 or 70A constitute a braking force control means and an operating cam 90.

First, the figures of the present disclosure illustrate, as an example, a representative embodiment in which a side cover on the palm side to which the spool cover is coupled is detachably coupled to one edge of a frame (not shown). Here, the attachment/detachment structure of the side cover on the palm side may be modified variously.

The figures illustrate an embodiment in which the rocking lever 50 or 50A disposed within the side cover 80 or 80A is configured to rotate about the outer circumferential surface of the spool cover. The locking protrusion 52 is attached to and detached from the frame as a fitting structure by rotating the rocking lever 50 or 50A using a handle 51 or 51′.

The other basic components of the fishing reel such as the frame (not shown) are known in the art and thus will not be described for the ease of understanding.

Specifically, the present disclosure includes:
the spool 10 including a drum 10a on which a fishing line is wound and a shaft 11 provided on the central portion;
a facing member provided on one side of the drum 10a of the spool 10 and including a facing portion 17;
a magnetic brake including holders provided in the circumferential direction of the facing portion of the facing member to be movable forwards and backwards in a direction perpendicular to the axial direction of the shaft 11 and magnets 41 mounted on the holders to respectively have a facing surface facing the facing portion; and
a braking force control means for moving the holders forwards and backwards.

In first, second, and third embodiments, the facing member having the facing portion 17 is integrally connected to one end of the spool 10, thereby omitting the variable brake 20 of a variable body. In a fourth embodiment, the facing member having a facing portion 21 is provided as a variable body including components separate from the spool 10 to function as a variable brake 20 in which the operating cam 90 is omitted.

In addition, as an essential feature of the present disclosure, the magnetic brake and the braking force control means have different configurations depending on the embodiment, and parts having the same names while differing in the essential configurations from one embodiment to another will be designated by different drawing symbols.

Other basic components of the fishing reel, such as the frame, which are not shown in the drawings, are known in the art and are not described for ease of understanding. First, each of the first, second, and third embodiments of the present disclosure includes:
the spool 10 including the drum 10a on which the fishing line is wound and the facing portion 17 connected to one edge of the drum 10a;
the magnetic brake including the holders 40A, 40B, 40C, or 40D provided in the circumferential direction of the facing portion 17 to be movable forwards and backwards in a direction perpendicular to the axial direction of the spool 10 and the magnets 41 mounted on the holders 40A, 40B, 40C, or 40D to respectively have a surface facing the facing portion 17; and
the braking force control means for moving the holders 40A, 40B, 40C, or 40D forwards and backwards.

Here, the facing surface of each of the magnets 41 refers to a figure in which opposite sides over a predetermined area where a large magnetic force is generated are facing each other inwardly and outwardly to be perpendicular to the axial direction of the spool 10. Although the drawings of the present specification illustrate a representative embodiment in which the magnet holders 40 are arranged in the direction of an inner surface of the facing portion 21 to form the facing surfaces of the magnets 41, the magnet holders 40 may be arranged in the direction of an outer surface of the facing portion 21 to form the facing surfaces of the magnets 41.

Thus, in contrast to magnet holders of the related art in which the magnets in the axial direction of the spool face the plate on one side of the spool and the magnetic force of the magnets acts in the axial direction of the spool, the present disclosure is characterized in that the magnetic force of the magnets 41 acts in the diameter direction of the spool 10, which is perpendicular to the axial direction of the spool 10.

Accordingly, the spool 10 has a cylindrical shape in which the facing portion 17 extends from one edge of the drum 10a in the axial direction of the spool 10 so as to face one of the inner and outer facing surfaces of the magnets 41.

In addition, the drawings of this specification illustrate, as a representative example, the spool 10 (i.e., a deep spool) in which a flange 12 is connected to and protrudes to the left and right along a side wall portion bent from one edge of the drum 10a at an angle close to the right angle (e.g., 80 to 90 degrees) with an increasing outer diameter. However, the spool 10 is not limited thereto. (For example, the entire spool may be completely cylindrical.)

In the case of a deep spool as in the present disclosure, the facing portion 17 has a cylindrical shape protruding from and connected to the flange 12 on one side of the spool 10.

In addition, the holders 40A, 40B, 40C, or 40D are a plurality of holders divided from each other and arranged radially.

That is, as an extreme example, a single holder having an arc shape may be provided so that the magnetic force acts on a portion of the facing portion 17, but a plurality of holders 40A, 40B, 40C, or 40D may be arranged radially in the circumferential direction of the spool 10 so that the magnetic force of the magnets 41 acts uniformly over the entire facing portion 17 of the spool 10.

In this case, as illustrated in FIGS. 1 to 6B, the holders 40A, 40B, or 40C may be radially arranged to have an outer diameter smaller than the inner diameter of the facing portion 17 so that the magnets 41 are received inside the facing portion 17, thereby allowing the magnetic force of the magnets 41 to act on the inner circumference of the facing portion 17.

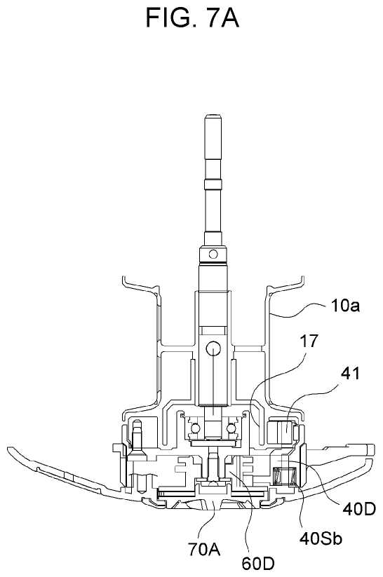

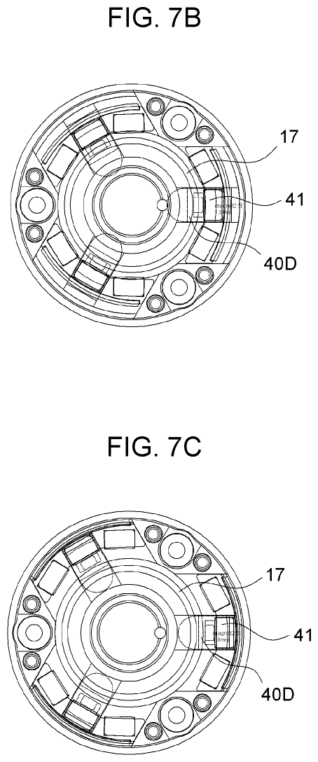

In another example, as illustrated in FIGS. 7A to 7C, the fourth holder 40D may be arranged on the outer side of the facing portion 17 in the direction of the diameter of the spool 10.

Hereinafter, the features regarding the detailed operation of the present disclosure will be specifically described on the basis of embodiments in each of which the holders 40A, 40B, or 40C are arranged on the inner side of the facing portion 17, and will briefly described on the basis of an embodiment in which the fourth holders 40D are arranged on the outer side of the facing portion 17.

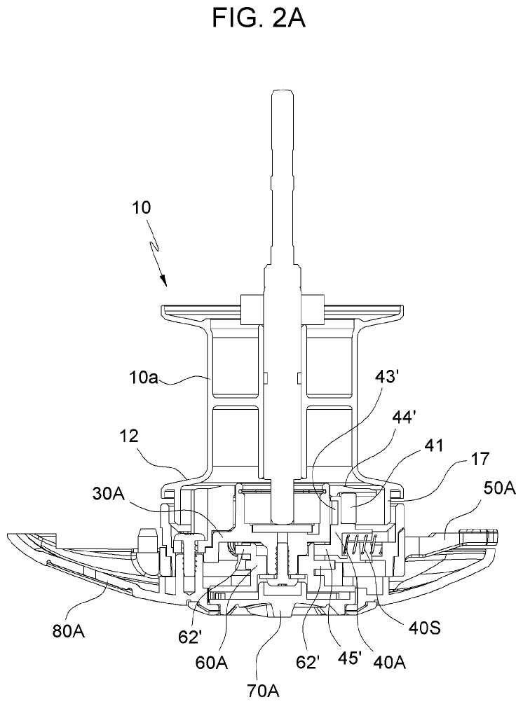

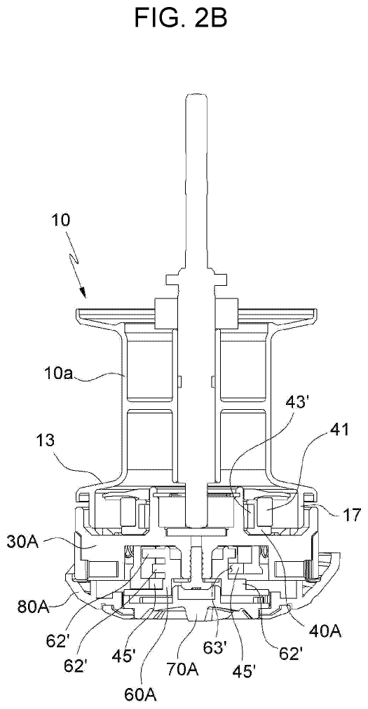

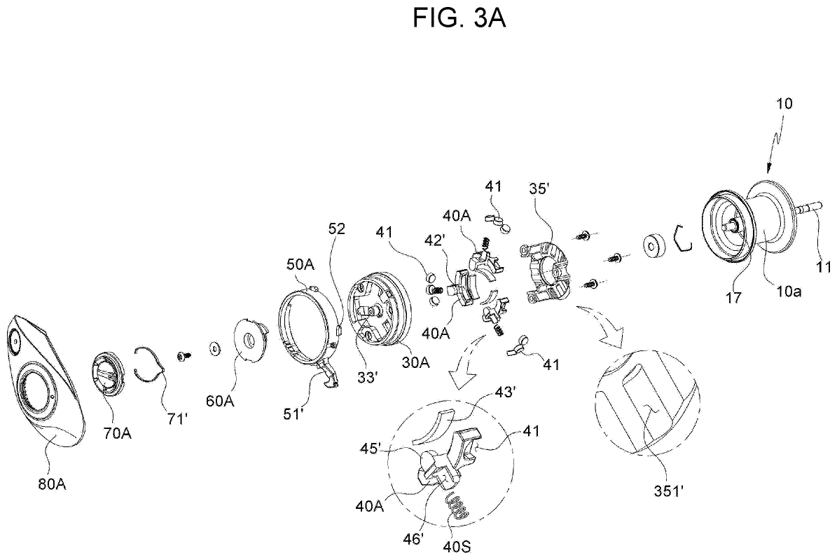

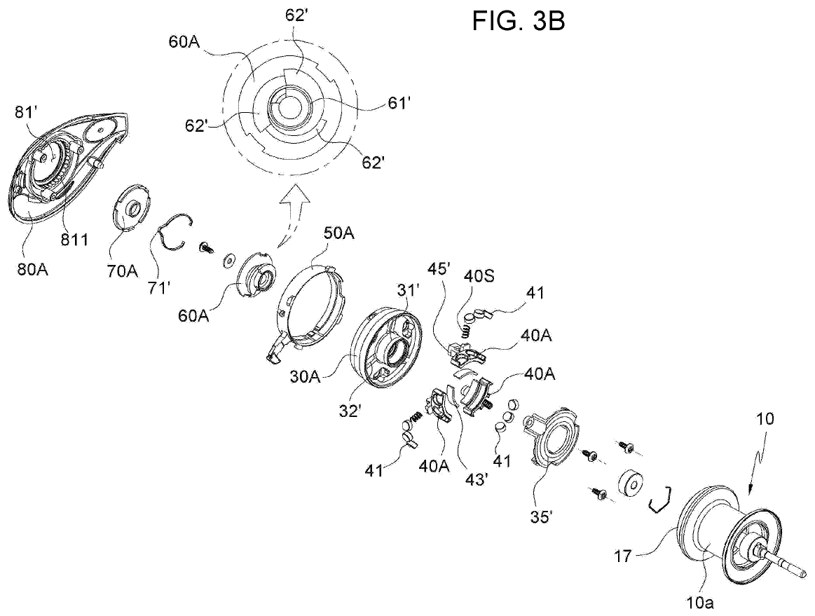

First, according to the first embodiment of the present disclosure, as illustrated in FIG. 2A to 3B,

The braking force control means includes:
a first dial cam 60A configured to rotate in the circumferential direction of the spool 10 at one side of each of the first holders 40A and including a cam portion configured to push the first holders 40A inwards or outwards to move forwards or backwards;
a control dial 70A provided on a side cover 80A to rotate the first dial cam 60A; and
an elastic member configured to elastically support the first holders 40A to move the first holders 40A backwards or forwards.

Referring to the first embodiment including three holders 40A, first, each of the first holders 40A has an arc-shaped first mounting recess 41′ provided on an outer circumferential surface and a second mounting recess 42′ provided on an inner portion.

The magnets 41 are fitted into the first mounting recess 41′. Here, the shape or number of the magnets 41 is not limited.

However, a plurality of coin-type magnets may be mounted on one first holder 40A, thereby allowing the number of the magnets 41 to be adjusted and set by each user.

Arc plates 43′ to which a magnetic force of the magnets 41 acts are fitted into the second mounting recess 42′, respectively.

The arc plates 43′ prevent the magnets 41 from being detached by attraction with the magnets 41.

Each of the arc plates 43′ is formed of a metal material or implemented as a magnet having a different polarity from the magnets 41 to cause each of the magnets 41 to be magnetically attracted toward the center of the holders 40A, 40B, 40C, or 40D, thereby preventing the magnets 41 from being separated or detached from the first mounting recess 41′.

In addition, the first holders 40A are protected with a fixing plate 35′ covering an open area of the other side of the first mounting recess 41′ and coupled to the spool cover 30A, thereby preventing the magnets 41 from being detached.

The fixing plate 35′ has guide grooves 351′ provided in surface portions in contact with the magnets 41 to extend in the radial direction so that portions of the magnets 41 are inserted into the guide grooves 351′. When the first holders 40A move forwards and backwards, the guide grooves 351′ guide the magnets 41. The fixing plate 35′ may be applied in the same manner to both the first embodiment and the second embodiment.

In addition, the first holders 40A are slide-coupled to the other side surface of the first spool cover 30A so that forward and backward movement thereof is guided.

In this regard, the first spool cover 30A has a central protrusion 31′ protruding from the central portion of the other side surface (i.e., the inner surface) to form a central portion of the first holders 40A and guide grooves 32′ radially arranged around the central protrusion 31′ and having predetermined distances in the radial direction of the spool cover 30A.

Each of the first holders 40A has a first pressed protrusion 45′ protruding from one side to be fitted into the corresponding guide groove 32′ and in contact with a pressing protrusion 62′ of the first dial cam 60A.

In addition, a distal end of the first pressed protrusion 45′ is bent inward to be inserted into a guide recess 63′ of the first dial cam 60A so that the guide recess 63′ may contact the pressing protrusion 62′ of the same height.

In this case, respective first pressed protrusions 45′ of the first holders 40A have different lengths (or heights) to form bends at different heights, and the respective first pressed protrusions 45′ are fitted into the guide recess 63′, i.e., a hollow space in which the pressing protrusion 62′ is not formed.

In addition, the first dial cam 60A has a column 61′ protruding from the central portion of the other side surface and the pressing protrusion 62′ protruding along the outer circumference of the column 61′ to support the first pressed protrusion 45′, with the height of the pressing protrusion 62′ gradually increase from one end to the other end. The pressing protrusion 62′ constitutes the cam portion according to the first embodiment.

A plurality of pressing protrusions 62′ are provided to protrude at different heights in the longitudinal direction of the column 61′, corresponding to the formation heights of the first pressed protrusions 45′ having different lengths, to form a hollow space referred to as the guide recess 63′ at the same height as the pressing protrusions 62′. Each of the first pressed protrusions 45′ is inserted and positioned in the guide recess 63′ of the corresponding pressing protrusion of the pressing protrusions 62′.

The first dial cam 60A is configured to rotate, with the column 61′ being axially fitted around an axial protrusion 33′ protruding from the central portion of one side surface (i.e., the outer surface) of the first spool cover 30A. The control dial 70A is coupled to the one side surface of the first dial cam 60A.

The control dial 70A is fitted into an axis hole 81′ of the side cover 80A to be operated to rotate, and includes an elastic pin 71′ engaged with a saw 811 provided on the inner circumferential portion of the axis hole 81′.

In addition, the elastic member according to the first embodiment includes a compression spring 40S pushing the first holders 40A inwards.

In this regard, each of the first holders 40A has a support recess 46′ on an outer surface of the first pressed protrusion 45′.

The spool cover 30A has seating recesses (not shown) on outer ends of the guide grooves 32′.

The opposite ends of the compression spring 40S are mounted in the radial direction of the spool 10 to be supported in the support recesses 46′ and the seating recesses to elastically support the first holders 40A inwards.

In the first embodiment described above, when the control dial 70A is rotated in one direction (i.e., the clockwise direction in the plan view in the circle of FIG. 3B), the pressing protrusion 62′ pushes the first pressed protrusion 45′ outwards to move the first holders 40A, i.e., the magnets 41, toward the facing portion 17, thereby increasing the braking force.

In contrast, when the control dial 70A is rotated in the other direction (i.e., the counterclockwise direction in the plan view in the circle of FIG. 3B), the pressing of the pressing protrusion 62′ to the first pressed protrusion 45′ may be removed and the elastic force of the compression spring 40S may act to the first pressed protrusion 45′ to move the first holders 40A, i.e., the magnets 41, away from the facing portion 17, thereby reducing the braking force.

Accordingly, the user may freely adjust the position of the magnets 41 using the control dial 70A to use the braking force by setting the braking force as required.

In addition, a modified embodiment in which the fourth holders 40D are arranged outside the facing portion 17 is illustrated in FIGS. 7A to 7C.

When the control dial 70A is rotated in the other direction, the pressing of the pressing protrusion 62′ is removed by the elastic force of a compression spring 40Sb. Thus, the elastic force of the compression spring 40Sb may act to the fourth holders 40D to move the fourth holders 40D, i.e., the magnets 41, toward the facing portion 17, thereby increasing the braking force.

In contrast, when the control dial 70A is removed in one direction, the pressing protrusion 62′ may push the fourth holders 40D outwards to move the fourth holders 40D, i.e., the magnets 41, away from the facing portion 17, thereby reducing the braking force.

The forward and backward movement of the fourth holders 40D may be modified into and designed as an operation mechanism of the second embodiment and first embodiment, and detailed description thereof will be omitted.

Subsequently, the second embodiment provided with two holders 40B differs from the first embodiment only in the specific connection and operation structure of the second holders 40B and the second dial cam 60B, and has a mechanism similar to the first embodiment in that the second holders 40B move forwards and backwards using the cam structure through the rotating second dial cam 60B.

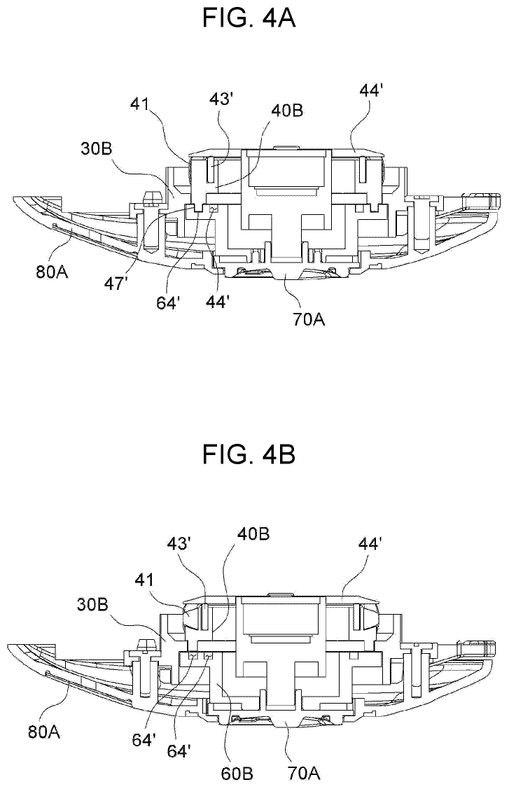

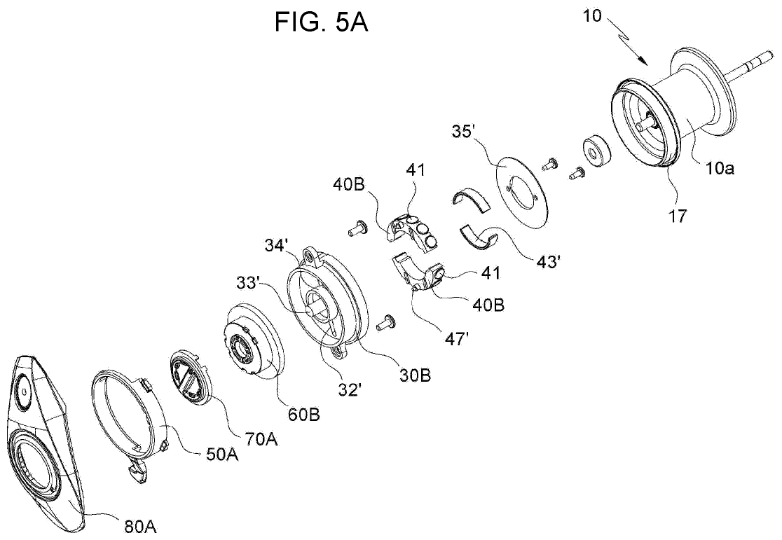

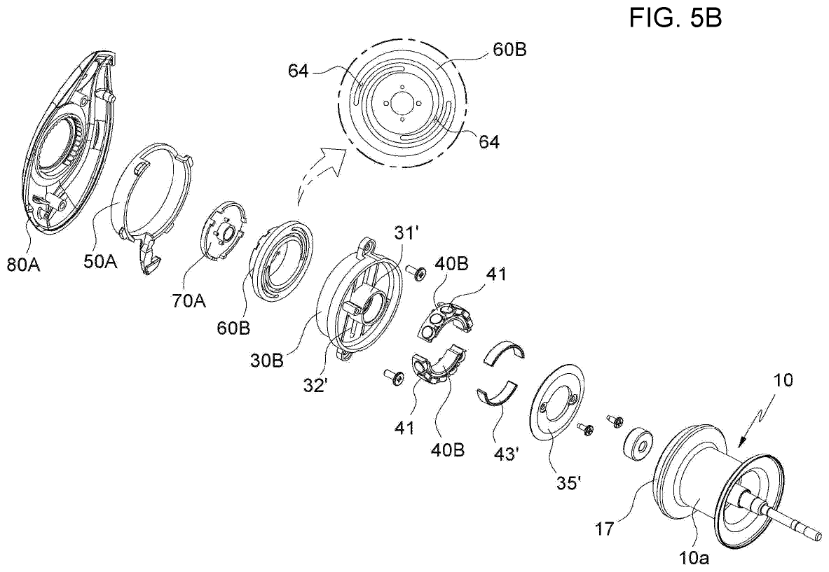

Specifically, as illustrated in FIGS. 4 to 5B, the braking force control means according to the first embodiment includes:
the second dial cam 60B configured to rotate in the circumferential direction of the spool 10 at one side of each of the second holders 40B and including a cam portion configured to push and move the second holders 40B inwards and outwards; and the control dial 70A provided on the side cover 80A to rotate the second dial cam 60B.

Like the first holders 40A, each of the second holders 40B includes the first mounting recess 41′ and the second mounting recess 42′ on the inner and outer surfaces, respectively. The corresponding magnet 41 and the corresponding arc plate 43′ are fitted into the mounting recesses 41′ and 42′, respectively.

Each of the second holders 40B has a second pressed protrusion 47′ protruding from one side to be fitted into the corresponding guide groove 32′ of the second spool cover 30B. Here, the second pressed protrusion 47′ has the shape of a rod having a circular cross-section.

In addition, the second dial cam 60B is axially mounted on a shaft 34′ provided on one side surface of the second spool cover 30B, with the control dial 70A being coupled to one side surface of the second dial cam 60B.

In addition, the second dial cam 60B includes a pressing recess 64′ provided on the other side surface in the circumferential direction such that the second pressed protrusion 47′ is fitted thereinto. The pressing recess 64′ is configured such that the distance from the central portion of the second dial cam 60B gradually increases from one distal end to the other distal end so as to press the second pressed protrusion 47′. The pressing recess 64′ constitutes the cam portion according to the first embodiment.

The pressing recess 64′ includes one edge provided at a position adjacent to the center of the second dial cam 60B and the other edge provided at a position adjacent to the periphery the second dial cam 60B, both the edges of the pressing recess 64′ are connected in a shape similar to a screw (e.g., a helical shape or a twisted shape).

The second pressed protrusion 47′ is fitted into the pressing recess 64′ through the linear guide groove 32′. Thus, when the second dial cam 60B rotates, the forward and backward positions of the second pressed protrusion 47′ change in the radial direction along the pressing recess 64′.

In the second embodiment described above,
when the control dial 70A is rotated in one direction (i.e., the clockwise direction in the plan view in the circle of FIG. 5B), the second pressed protrusion 47′ is pushed toward the periphery of the second dial cam 60B along the pressing recess 64′ to move the second holders 40B, i.e., the magnets 41, toward the facing portion 17, thereby increasing the braking force.

In contrast, when the control dial 70A is rotated in the other direction (i.e., the counterclockwise direction in the plan view in the circle of FIG. 5B), the second pressed protrusion 47′ is pushed toward the center of the second dial cam 60B along the pressing recess 64′ to move the second holders 40B, i.e., the magnets 41, away from the facing portion 17, thereby reducing the braking force.

The third embodiment provided with two holders 40C differs from the first embodiment and the second embodiment in the position of the third holders 40C being changed forwards and backwards using the operating cam 90 operated to move forwards and backwards in the axial direction of the spool 10.

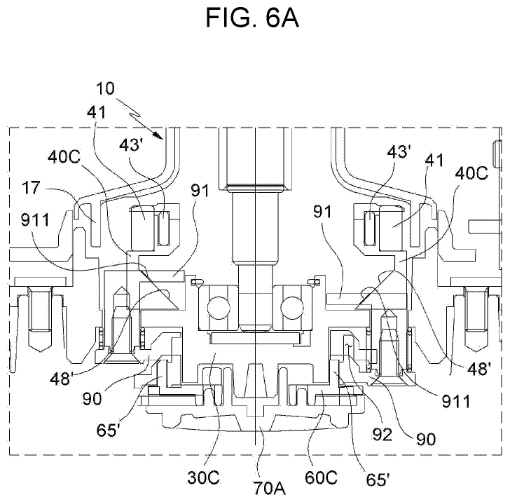

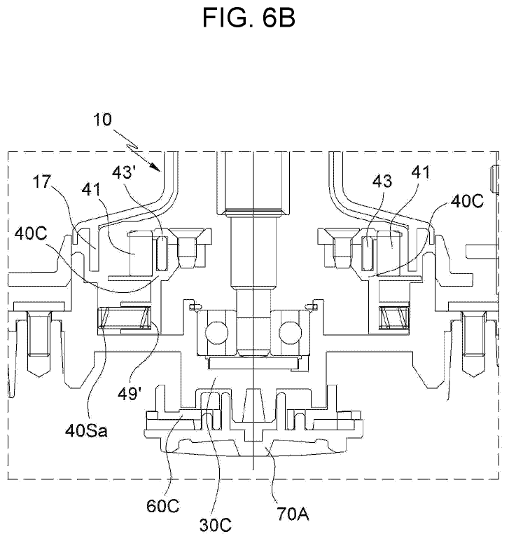

Specifically, as illustrated in FIGS. 6A and 6B, the braking force control means according to the third embodiment includes:
the operating cam 90 configured to move forwards and backwards in the axial direction of the spool 10 at one side of each of the third holders 40C and including a cam portion configured to push the third holders 40C inwards or outwards to move forwards or backwards;
the third dial cam 60C configured to rotate in the circumferential direction of the spool 10 at one side of the operating cam 90 and push the operating cam 90 in the axial direction to move forwards;
the control dial 70A provided on the side cover 80A to rotate the third dial cam 60C; and
the elastic member configured to elastically support the third holders 40C outwards or inwards to move backwards or forwards.

As in the other embodiments, the magnets 41 are mounted on the outer surfaces of the third holders 40C and the arc plates 43′ are mounted on the inner surfaces of the third holders 40C.

Each of such third holders 40C has a first slope 48′ provided on the inner surface. The first slope 48′ is inclined upward in the axial direction of the spool 10 and from inside to outside in the radial direction.

In addition, the operating cam 90 is fitted around the shaft 34′ of the third spool cover 30C to be operated to move forwards and backwards in the axial direction, and includes a pressing portion 91 connected by extending through the third spool cover 30C. A second slope 911 corresponding to the first slope 48′ is provided at the outer edge of the pressing portion 91. The pressing portion 91 constitutes the cam portion according to the third embodiment.

A cam recess 92 similar to the pressing recess 64′ is provided on one side surface (i.e., an outer surface) of the operating cam 90.

The third dial cam 60C is coupled to the other side surface of the control dial 70A to rotate together. Here, a support protrusion 65′ fitted into and in surface contact with the cam recess 92 protrudes from the inner surface (i.e., the other side surface).

The cam recess 92 and the support protrusion 65′ are configured such that the lowermost points are connected to the uppermost points in the circumferential direction and at an inclination. When the lowermost point and the uppermost point are in surface contact with the uppermost point and the lowermost point of the support protrusion 65′, the operating cam 90 moves backwards in the axial direction to be at the maximum distance from the third holders 40C. The contact height of the cam recess 92 and the support protrusion 65′ varies in response to the rotation of the third dial cam 60C. As a result, the operating cam 90 moves forwards toward the third holders 40C.

In addition, the elastic member according to the third embodiment includes a compression spring 40Sa configured to press the third holders 40C outwards.

In this regard, the third holders 40C is provided with a fitting recess 49′ on the outer surface of a guide extending from one side of each of the magnets 41. The fitting recess 49′ allows the compression spring 40Sa to be fitted thereinto.

The compression spring 40S is mounted in the radial direction of the spool 10 such that both ends thereof are supported on the sidewall of the third spool cover 30C and the fitting recess 49′, and elastically supports the third holders 40C inwards.

In the third embodiment described above,
when the control dial 70A is rotated in one direction, the operating cam 90 is moved backwards in the axial direction by the third dial cam 60C so that the second slope 911 moves downwards on the first slope 48′ to push the third holders 40C outwards to move the magnets 41 towards the facing portion 17, thereby increasing the braking force.

In contrast, when the control dial 70A is rotated in the other direction, the dial cam 60C is moved forwards to remove the pressing on the second slope 911. As a result, the elastic force of the compression spring 40S acts to the third holders 40C to move the magnets 41 away from the facing portion 17, thereby reducing the braking force.

In addition, the fourth embodiment including two holders 40 includes:
the spool 10 configured such that the shaft 11 extends therethrough to be axially mounted on a reel body and a fishing line is wound thereon;
the variable brake 20 including a facing portion 21 provided in the circumferential direction of the spool 10, wherein the variable brake 20 is coupled to one end of the shaft 11 to be movable forwards and backwards in the axial direction of the spool 10 and is elastically supported toward the spool 10;
the magnet holders 40 provided in the circumferential direction of the facing portion 21, coupled in the direction of the inner or outer circumferential surface of the facing portion 21 to be movable forwards and backwards in a direction perpendicular to the axial direction of the spool 10, and including magnets 41 mounted to form opposing surfaces with respect to the facing portion 21; and
the braking force control means for moving the magnet holders 40 forwards and backwards.

In addition, the braking force control means includes:
the dial cam 60 configured to rotate in the circumferential direction of the spool 10 at one side of the magnet holders 40 and including a cam portion configured to press and move the magnet holders 40 forwards and backwards in a direction perpendicular to the axial direction of the spool 10; and
the control dial 70 provided on the side cover 80 to rotate the dial cam 60.

In addition, the variable brake 20 is a variable body configured to move forwards and backwards with respect to the spool 10, and has the shape of a ring in which the facing portion 21 is arranged in parallel to the spool 10 in the axial direction so that the variable brake 20 faces the inner or outer opposing surfaces of the magnets 41

Within the spool 10, a pipe-shaped shaft coupling portion 13 is provided in the axial direction such that the shaft 11 extends through and is coupled to the shaft coupling portion 13.

In addition, a support cap 15 is coupled to one end of the shaft 11 by means of a binding ring 14 such as a C-ring. As one end of a compression spring 16 is supported on the support cap 15 and the other end of the compression spring 16 is supported on the variable brake 20, the variable brake 20 is pressed in the direction of the spool 10 to move backwards.

One side surface (i.e., an outer surface) of the variable brake 20 is open due to the facing portion 21 extending in the shape of a flange. A shaft fitting portion 22 protrudes from a central portion of one side, and the shaft 11 extends through and fitted to the shaft fitting portion 22. A plurality of through-holes 23 are arranged radially in the variable brake 20 to reduce the weight of the variable brake 20.

In addition, the variable brake 20 is configured to move forwards and backwards in the axial direction of the spool 10 due to a centrifugal action in response to the rotation of the spool 10, and includes a fixed cam 24 coupled to an open area on one side of the spool 10 and a variable cam 24 coupled to the other side surface (i.e., the inner surface) of the variable brake 20.

The fixed cam 24 and the variable brake 20 are matingly coupled to each other in an engagement structure, and contact surfaces of the fixed cam 24 and the variable brake 20 have cam slope portions 241 and 251 having a predetermined degree of slope.

When the rotation of the spool 10 accelerates, the second cam slope portion 251 of the variable brake 20 coupled to the variable brake 20 is pushed in one direction (e.g., outwards) by the first cam slope portion 241 of the fixed cam 24 fixed to the spool 10 so that the variable brake 20 moves forwards to be spaced apart from the spool 10.

When the rotation of the spool 10 decelerates, variable brake 20 moves backwards and returns to the original position due to the elastic force of the compression spring 16.

Here, as the forward movement of the variable brake 20 varies depending on the centrifugal force, i.e., the speed of rotation of the spool 10, the strength of the magnetic force of the magnets 41 acting on the facing portion 21 may change, thereby appropriately controlling braking force according to the speed of rotation of the spool 10.

The spool cover 30 covers the facing portion 21 of the variable brake 20 in a position in which the spool cover 30 is coupled to the side cover 80, thereby holding the spool 10 and the variable brake 20.

The spool cover 30 has the shape of a drum compartmentalized by a central partition, with one and the other sides being open. The magnet holders 40 are fitted to a receiving portion 31 in the open area at the other side.

The spool cover 30 has a shaft fitting portion 32 protruding at the center of the receiving portion 31. As a backing member 33 and a bearing 34 are mounted on the shaft fitting portion 32, one end of the shaft 11 is fitted into and supported by the bearing 34.

In addition, the spool cover 30 further includes a fixing plate 35 coupled to the receiving portion 31, the open area on the other side, of the spool cover 30 while covering the magnet holders 40.

The fixing plate 35 allows the bearing 34 to be fitted and coupled thereto, and covers the open area on the other side of mounting recesses 42 in which the magnets 41 are fitted, thereby preventing the magnets 41 from being separated or detached from the magnet holders 40.

In addition, a shaft protrusion portion 36 protrudes in the open area on one side of the spool cover 30, the dial cam 60 is axially mounted on the shaft protrusion portion 36, and guide grooves extending in the forward-backward movement direction of the magnet holders 40 are formed in the partition of the spool cover 30.

The guide recesses include first guide recesses 37 to which protrusions 44 which are to be pressed of the magnet holders 40 approach and second guide recesses 38 to which guide protrusions 45 magnet holders 40 approach.

Here, the numbers and the arrangements of the guide protrusions 45 and the second guide recesses 38 may be varied. An embodiment in which the guide protrusions 45 are provided on both sides of the to-be-pressed protrusions 44 located at the center and the second guide recesses 38 are provided on both sides of the first guide recesses 37 located at the center can be seen from the figures.

Next, the magnet holders 40 slide in the open area on the other side in a direction perpendicular to the axial direction of the spool 10. The figures illustrate a shape in which two semicircular magnet holders 40 are coupled to each other while being opposed with respect to the shaft fitting portion 32 such that the magnets 41 are arranged in a circle like the facing portion 21, but the number of the magnet holders 40 may vary.

In each of the magnet holders 40, portions of the outer circumferential surface are open to form a radial arrangement of the mounting recesses 42 with the other ends (i.e., the inner ends) thereof being open. The magnets 41 are fitted and coupled to the mounting recesses 42, respectively. Here, the shape and the number of the magnets 41 are not limited.

Because a plurality of coin-shaped magnets 41 may be mounted on a single magnet holder 40, the number of the magnets 41 may be adjusted and set according to the user.

Arc plates 43 to which the magnetic force of the magnets 41 acts are mounted on the inner circumferential surfaces of the magnet holders 40, respectively.

The arc plates 43 prevent the magnets 41 from being separated by attraction with the magnets 41.

The arc plates 43 are formed of a metal material or implemented as magnets having different polarities from the magnets 41, and the magnets 41 are covered with the fixing plate 35 while being magnetically attracted toward the center of the magnet holders 40. In this manner, the magnets 41 are prevented from being separated or detached from the mounting recesses 42.

In addition, each of the magnet holders 40 includes the protrusions 44, which are to be pressed, and the guide protrusions 45 protruding from one side surface thereof.

The protrusions 44, which are to be pressed, have the shape of circular rods, and are fitted to pressing recesses 61 of the dial cam 60 through the first guide recesses 37.

The guide protrusions 45 have a rectangular shape and are fitted to the second guide recesses 38 to guide forward and backward movements of the magnet holders 40.

In the dial cam 60, when rotated, the cam portions (i.e., the pressing recesses 61) press the protrusions 44, which are to be pressed, in a direction perpendicular to the axial direction of the spool 10, thereby moving the magnet holders 40 forwards and backwards.

The cam portions include the pressing grooves 61 each circumferentially formed in the other side surface of the dial cam 60 such that a corresponding one of the protrusions 44, which are to be pressed, is fitted thereto. The cam portion is configured to press the corresponding protrusion 44, which are to be pressed, with the distance thereof from the center of the dial cam 60 gradually increasing in the direction from one end to the other end thereof.

The control dial 70 is coupled to one side surface (i.e., the outer surface) of the dial cam 60 which is axially mounted while being received in the spool cover 30.

Each of the pressing grooves 61 extends in a shape similar to a spiral shape (e.g., a helical shape or a twisted shape) such that one end is formed at a position in the vicinity of the center of the dial cam 60 and the other end is formed at a position in the vicinity of the edge of the dial cam 60.

Because the protrusions 44, which are to be pressed, are fitted to the pressing grooves 61 through the linear first guide recesses 37, when the dial cam 60 rotates, the protrusions 44, which are to be pressed, move forwards and backwards radially in the pressing grooves 61 so that the positions of the magnet holders 40 are changed.

In addition, the dial cam 60 has a plurality of click recesses 62 formed inside the pressing grooves 61 to extend in the circumferential direction, and an elastic pin provided on the spool cover 30 is caught by one of the click recesses 62.

In addition, the control dial 70 coupled to the dial cam 60 is exposed externally through a rotation hole of the side cover 80.

An identifier 71 including symbols, numbers, or the like is provided on one side surface (i.e., an outer surface) of the control dial 70 to have the shape of a circle in order to indicate the position of rotation (e.g., the angle) of the control dial 70. An indicator is provided at one position in the circumferential direction of the rotation hole.

Accordingly, a user may adjust the position of the magnets 41 with respect to the facing portion 21, i.e., the distance between the facing portion 21 and the magnets 41, by adjusting the forward and backward positions of the magnet holders 40 by rotating the dial cam 60 using the control dial 70.

In a state in which basic braking force is set according to the user, when a fishing line is cast, the position of the variable brake 20 changes depending on the speed of rotation of the spool 10, and a corresponding braking force may be applied, thereby preventing backlash or a decrease in the flying distance in the casting.

Although the fishing reel according to the exemplary embodiments of the present disclosure has been described for illustrative purposes, those skilled in the art will appreciate that various modifications, additions, and substitutions are possible, without departing from the scope and spirit of the present disclosure as disclosed in the accompanying claims.

What is claimed is:

1. A fishing reel including:
a spool including a drum on which a fishing line is wound and a shaft provided on a central portion;
a facing member provided on one side of the drum of the spool and including a facing portion;
a magnetic brake including holders provided in a circumferential direction of the facing portion of the facing member to be movable forwards and backwards in a direction perpendicular to an axial direction of the shaft and magnets mounted on the holders to respectively have a facing surface facing the facing portion; and
a braking force control means for moving the holders forwards and backwards.

2. The fishing reel of claim 1, wherein the braking force control means includes:
a dial cam configured to rotate in a circumferential direction of the spool at one side of each of the first holders and including a cam portion configured to push the first holders inwards or outwards to move forwards or backwards; and
a control dial provided on a side cover to rotate the dial cam.

3. The fishing reel of claim 1, wherein the braking force control means includes:
an operating cam configured to move forwards and backwards in an axial direction of the spool at one side of each of the third holders and including a cam portion configured to push the third holders inwards or outwards to move forwards or backwards;
a dial cam configured to rotate in a circumferential direction of the spool at one side of the operating cam and push the operating cam in an axial direction to move forwards; and
a control dial provided on a side cover to rotate the dial cam.

4. The fishing reel of claim 1, wherein the facing member is a variable body coupled to one edge of the shaft to move forwards and backwards in an axial direction of the spool, and
the holders of the magnetic brake are provided in the circumferential direction of the facing portion and are configured to move forwards and backwards in a direction perpendicular to the axial direction of the spool in a direction of an inner surface or an outer surface of the facing portion.

5. The fishing reel of claim 4, wherein the variable body is elastically supported toward the spool.

6. The fishing reel of claim 4, wherein the braking force control means includes:
a dial cam configured to rotate in a circumferential direction of the spool at one side of the holders and push the holders in a direction perpendicular to an axial direction of the spool to move forwards; and
a control dial provided on a side cover to rotate the dial cam.

7. The fishing reel of claim 4, further including a spool cover at one side of the holders, wherein a receiving portion in which the holders are received is defined by the spool cover, and the spool cover includes guide grooves configured to guide the holders in a direction perpendicular to the axial direction of the spool.
